(19) United States
(12) Patent Application Publication
(10) Pub. No.: US 2026/0044550 A1
(43) Pub. Date: Feb. 12, 2026

(54) METHOD AND SYSTEM FOR PROVIDING INDIVIDUALIZED AND INTERACTIVE REMOTE EDUCATION

(71) Applicant: ProphetStor Data Services, Inc., Taichung (TW)

(72) Inventors: Wen-Shyen Chen, Taichung City (TW); Jonathan Chen, Milpitas, CA (US)

(21) Appl. No.: 18/799,386

(22) Filed: Aug. 9, 2024

(51) Int. Cl. G06F 16/335; G06Q 50/20

(52) U.S. Cl. CPC G06F 16/335; G06Q 50/205

(57) ABSTRACT

The present invention provides a method for providing individualized and interactive remote education and a system thereof. The method includes the steps of: storing educational materials and links to remote databases and/or library resources; providing educational materials to the educational material database and updating the educational materials stored in the educational material database; maintaining a user profile for each user; generating an individualized learning program for each user based on the user profile; and autonomously producing content to the user and forwarding user feedback via a generative artificial intelligence (AI) module.

### FIELD OF THE INVENTION

The present invention relates to a method and a system for providing individualized and interactive remote education. More particularly, the present invention relates to a method and a system for providing individualized and interactive remote education through a natural language interaction application.

### BACKGROUND OF THE INVENTION

The year 2020 witnessed a substantial transformation in global education due to the profound effects of the COVID-19 pandemic. The widespread closure of schools and universities, implemented as a measure to contain the virus's spread, prompted a notable surge in the embrace of online education. Faced with the necessity to adapt swiftly, numerous educational institutions transitioned to remote learning modalities to guarantee the uninterrupted flow of education.

Despite the longstanding presence of online education, current systems predominantly replicate the traditional physical teaching model in a digital format, falling short of delivering a personalized and interactive learning experience. For instance, U.S. Pat. No. 10,908,803 outlines a method for sharing media files within an online collaborative discussion (OCD) room, where participants can view and interact with a shared canvas. While this technology allows for collaborative actions such as marking and editing objects on the canvas, it does not sufficiently cater to the need for a truly individualized and interactive learning experience.

Here are some potential drawbacks of traditional online education:
1. Traditional online education platforms often employ a generalized approach to learning. This may result in suboptimal student engagement and unrealized academic potential, suggesting that students may not receive content and support tailored to their specific needs and learning styles.
2. Some platforms, like Khan Academy's Khanmigo, may use a guided approach with prompts for problem-solving. However, this guided approach might limit the interactive and immersive nature of the learning experience, potentially hindering user engagement and the development of a more natural, dialogue-like interaction.
3. Traditional platforms may lack dynamic customization based on real-time user metrics. Without continuous analysis of learning history, assessment outcomes, and real-time progress, traditional platforms may struggle to adapt and refine the educational pathway for individual students, possibly leading to a less personalized experience.
4. Traditional platforms might be confined to specific educational content. This limitation contrasts with the proposed system's multi-modal content delivery, suggesting that traditional platforms may not provide as comprehensive and enriched learning experiences by aggregating materials from various sources.
5. Traditional platforms may lack a robust real-time assessment mechanism. Without instantaneous feedback, identifying and addressing learning gaps promptly becomes challenging. This delay in assessment and feedback could hinder the efficiency of the learning process.
6. Traditional platforms may offer a more generalized form of personalization. However, the distinction is made between “personalized” and “tailored-made” individualization, suggesting that traditional platforms might lack the specificity and customization provided by the present invention.

In summary, the drawbacks of traditional online education platforms, as implied in the provided paragraphs, include limiting teachers to a fixed set of tools, employing a one-size-fits-all approach that may not address individual preferences, relying on a single source for educational resources leading to a narrow learning experience, utilizing static assessments that don't adapt to students' learning curves, and using metrics that overlook nuanced aspects of user engagement and cognitive load.

The present invention aims to address these drawbacks by introducing an AI-driven educational system with advanced features to enhance user engagement, provide real-time customization, and offer a more individualized learning experience. Specifically speaking, the present invention aims to provide teachers with dynamic content customization, enabling real-time adaptation of educational materials through analytics and ML algorithms, thereby ensuring continual optimization aligned with each student's unique learning profile. Utilizing advanced NLP and ML algorithms, the invention analyzes various metrics to craft personalized learning pathways, integrating diverse educational resources for a comprehensive experience. Adaptive assessments evolve in real-time based on student performance, serving both evaluative and formative functions. Advanced ML models scrutinize nuanced aspects of user engagement, allowing targeted interventions for an enhanced learning experience. The invention also facilitates peer-to-peer interaction, and collective problem-solving, and fosters a sense of community among students. Designed for universal accessibility, it ensures quality education across various platforms and devices, making it available to a diverse demographic.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims. The following presents a simplified summary of one or more aspects of the present disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

The invention aims to set a new standard in online education by amalgamating the following key features, providing a more effective, engaging, and individualized learning experience through cutting-edge technologies such as Natural Language Processing (NLP) and Machine Learning (ML), including Generative AI. It addresses the drawbacks of traditional platforms, offering solutions such as an interactive learning experience, dynamic customization, multi-source content delivery, real-time assessments, and specific, tailored-made individualization. The proposed system transcends the capabilities of existing platforms, introducing a transformative approach to online education for teachers, students, and content providers alike.
1. Multi-Directional Systems: Distinct interfaces for teachers, students, and content providers. teachers can upload and curate content while engaging with students through an intelligent, conversational AI interface. Students can access a variety of resources, ask questions, and receive immediate, personalized feedback.
2. Dynamic Content Integration: Amalgamation of educational resources from diverse origins, including traditional classrooms, specialized educational databases, and the internet. Enhances the richness and comprehensiveness of the educational experience.
3. Real-Time Adaptation and Personalization: Advanced NLP algorithms for query understanding. ML models for real-time adaptation of educational pathways based on user interactions, learning history, and assessment outcomes.
4. Adaptive Assessments and Feedback Loop: Dynamic assessment mechanism that evaluates the student's understanding. Adapts educational materials in real-time, contributing to continuous refinement of the educational experience.
5. Tailored-Made Individualization: Emphasis on the term “tailored-made” to underscore a high degree of customization. Sets the system apart from other “personalized” educational platforms by offering multi-modal, individualized learning pathways.

In one aspect, the present invention provides a method for providing individualized and interactive remote education which includes the steps of: storing educational materials and links to remote databases and/or library resources; providing educational materials to the educational material database and updating the educational materials stored in the educational material database; maintaining a user profile for each user; generating an individualized learning program for each user based on the user profile; and autonomously producing content to the user and forwarding user feedback via a generative artificial intelligence (AI) module.

Preferably, the user profile comprises academic profile, learning preferences, and historical engagement metrics of the user.

Preferably, the user profile comprises learning styles, preferences, and objectives of the user, and the autonomously produced content is adjusted accordingly by the generative AI module.

Preferably, the user profile comprises a dynamically updated record of a learning progress of the individualized learning program for the user to accomplish, with the learning progress being tracked and accessible.

Preferably, the autonomously produced content is generated by Natural Language Processing (NLP) and Machine Learning (ML) algorithms.

Preferably, the educational materials are dynamically uploaded and modified via machine learning-driven analytics, facilitating real-time engagement and personalized interventions with the user.

Preferably, the generative AI module provides immediate access to a curated and diverse array of educational resources, and delivers AI-driven, real-time feedback based on interactions and performance metrics of the user.

Preferably, the educational materials are deployable in both on-premise and cloud-based environments, offering unparalleled content management and distribution flexibility.

Preferably, the educational materials comprise textbooks, videos, and quizzes.

Preferably, difficulty of the individualized learning program is adjusted dynamically based on the user feedback.

In another aspect, the present invention provides a system for providing individualized and interactive remote education which includes: an educational material database, for storing educational materials and links to remote databases and/or library resources; a teacher subsystem, connected to the educational material database, for providing educational materials to the educational material database and updating the educational materials stored in the educational material database; a student subsystem, connected to the educational material database, for storing a user profile for each user; an assessment subsystem, connected to the teacher subsystem and the student subsystem, for generating an individualized learning program for each user based on the user profile; and a generative artificial intelligence (AI) module, connected to the educational material database, the teacher subsystem, the student subsystem, and the assessment subsystem, for autonomously producing content to the user and forwarding user feedback to the teacher subsystem, the student subsystem, and the assessment subsystem.

Preferably, the user profile comprises academic profile, learning preferences, and historical engagement metrics of the user.

Preferably, the user profile comprises learning styles, preferences, and objectives of the user, and the autonomously produced content is adjusted accordingly by the generative AI module.

Preferably, the user profile comprises a dynamically updated record of a learning progress of the individualized learning program generated by the assessment subsystem for the user to accomplish, with the learning progress being tracked by the assessment subsystem and accessible to the teacher subsystem.

Preferably, the autonomously produced content is generated by Natural Language Processing (NLP) and Machine Learning (ML) algorithms.

Preferably, the teacher subsystem is equipped with machine learning-driven analytics that enables the dynamic upload and modification of the educational materials while facilitating real-time engagement and personalized interventions with the user.

Preferably, the student subsystem provides immediate access to a curated and diverse array of educational resources via the educational material database, and delivers AI-driven, real-time feedback based on interactions and performance metrics of the user via the generative AI module.

Preferably, the educational material database is deployable in both on-premise and cloud-based environments, offering unparalleled content management and distribution flexibility.

Preferably, the educational materials comprise textbooks, videos, and quizzes.

Preferably, difficulty of the individualized learning program is adjusted dynamically based on the user feedback.

### BRIEF DESCRIPTION OF THE DRAWINGS

FIG. 1 is a block diagram illustrating major components of a system for providing individualized and interactive remote education according to an embodiment of the present invention.

FIG. 2 is a flowchart illustrating a method for providing individualized and interactive remote education according to an embodiment of the present invention.

FIG. 3 is a conceptual overview of the invention from the viewpoint of a student.

FIG. 4 is a conceptual overview of the invention from the viewpoint of a teacher.

FIG. 5 is a conceptual overview of the invention from the viewpoint of an educational material database.

### DETAILED DESCRIPTION OF THE PREFERRED EMBODIMENTS

The present invention will now be described more specifically with reference to the following embodiments. The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form to avoid obscuring such concepts.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation.

The present invention provides a system and a method for providing individualized and interactive remote education by use of a natural language interaction application/generative AI application that is based on Natural Language Processing (NLP) and Machine Learning (ML) technologies to deliver a personalized, immersive, and conversational AI-driven educational experience. Natural language interaction application/generative AI application is a software application that uses natural language to interact with a user. It performs functions similar to those provided by human assistants, in that they can engage in conversations with their users in order to for example provide information, carry out routine tasks, or perform other operations as required. Examples of applications featuring natural language interaction and generative AI include Apple's Siri, Amazon's Alexa, Google's BERT, and OpenAI's ChatGPT. It's important to note that the present invention extends beyond these instances and is not limited to the mentioned technologies.

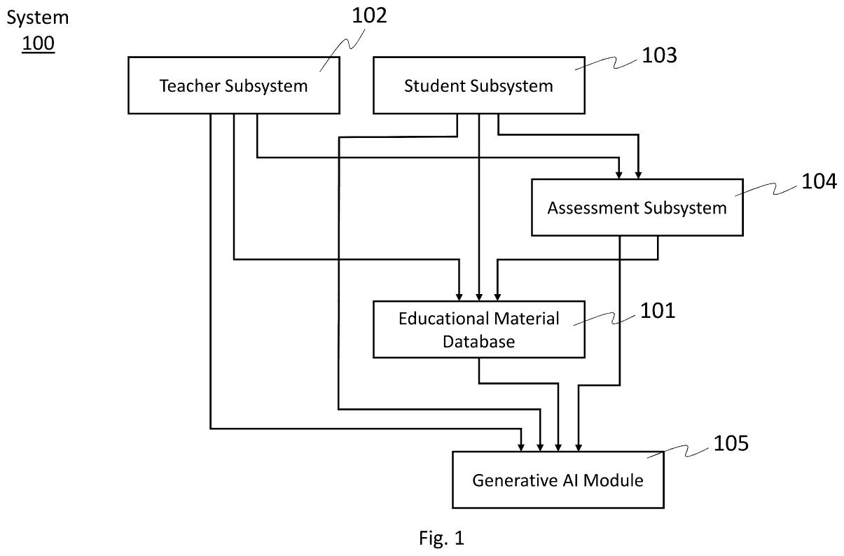

FIG. 1 is a block diagram illustrating major components of a system 100 for providing individualized and interactive remote education according to an embodiment of the present invention. The system 100 aims to provide a universally accessible, highly responsive, and deeply personalized learning environment. The system 100 is inherently scalable and capable of accommodating a diverse and expansive user base, including students and teachers from various demographic and academic backgrounds. As shown, the system 100 includes: an educational material database 101, a teacher subsystem 102, a student subsystem 103, an assessment subsystem 104, and a generative artificial intelligence (AI) module 105. The system 100 for providing individualized and interactive remote education is a comprehensive platform designed to optimize the learning experience. The educational material database 101 serves as a centralized repository for storing educational materials and links to remote databases and library resources. The educational material database 101 is designed to aggregate and curate educational materials from various sources, including academic journals, textbooks, and interactive online modules. Linked to the educational material database 101 are the teacher subsystem 102 and the student subsystem 103. The teacher subsystem 102 facilitates the provision of educational materials to the database 101 and ensures updates to the stored content. The teacher subsystem 102 is also being used for curriculum design, content adaptation, and real-time student monitoring, thereby enabling targeted educational interventions. The teacher subsystem 102 further offers real-time analytics and interactive tools to enhance student engagement and facilitate personalized education.

The student subsystem 103 is responsible for managing user profiles, creating a personalized space for each individual. The student subsystem 103 is integrated with recommendation engines and feedback mechanisms that utilize machine learning algorithms to personalize the educational pathway. The assessment subsystem 104, connected to both the teacher subsystem 102 and the student subsystem 103, generates individualized learning programs based on user profiles, tailoring the educational experience to each student. The assessment subsystem 104 generates actionable insights into student performance through machine learning algorithms that enable real-time educational interventions. Additionally, the generative AI module 105 enhances the system's autonomy by producing content for users and efficiently forwarding user feedback to the teacher subsystem 102 and the student subsystem 103, as well as the assessment subsystem 104. This integrated approach ensures a dynamic and personalized remote education experience for users.

According to the present embodiment, the user profile is a multifaceted representation of each user/student, encompassing their academic profile, learning preferences, and historical engagement metrics. The user profile guides the generative AI module 105 in tailoring autonomously produced content to the individual user's learning styles, preferences, and objectives. Notably, the user profile serves as a dynamic record of the user's progress through the individualized learning program generated by the assessment subsystem 104. This progress is continuously tracked by the assessment subsystem 104, ensuring a comprehensive overview accessible to the teacher subsystem 102 for informed insights and interventions.

The generative AI module 105 utilizes sophisticated Natural Language Processing (NLP) and Machine Learning (ML) algorithms to create autonomously produced content, adding a layer of adaptability and responsiveness to the learning materials. Meanwhile, the teacher subsystem 102 employs machine learning-driven analytics, enabling the dynamic upload and modification of educational materials. This functionality facilitates real-time engagement and personalized interventions, enhancing the overall educational experience for the user.

In the student subsystem 103, immediate access to a curated selection of diverse educational resources is provided through the educational material database 101. The educational material database 101 is deployable in both on-premise and cloud-based environments, ensures unparalleled flexibility in content management and distribution, and is universally accessible. Additionally, the student subsystem 103 delivers AI-driven, real-time feedback based on user interactions and performance metrics through the generative AI module 105, fostering an interactive and responsive learning environment.

The educational materials themselves encompass a variety of formats, including textbooks, videos, and quizzes. The adaptive nature of the system 100 is further highlighted by the dynamic adjustment of the difficulty level in response to user feedback, ensuring that the individualized learning program evolves in tandem with the user's progress and needs. This comprehensive and adaptive approach exemplifies the cutting-edge capabilities of this remote education system 100, offering a personalized and engaging learning journey for each user.

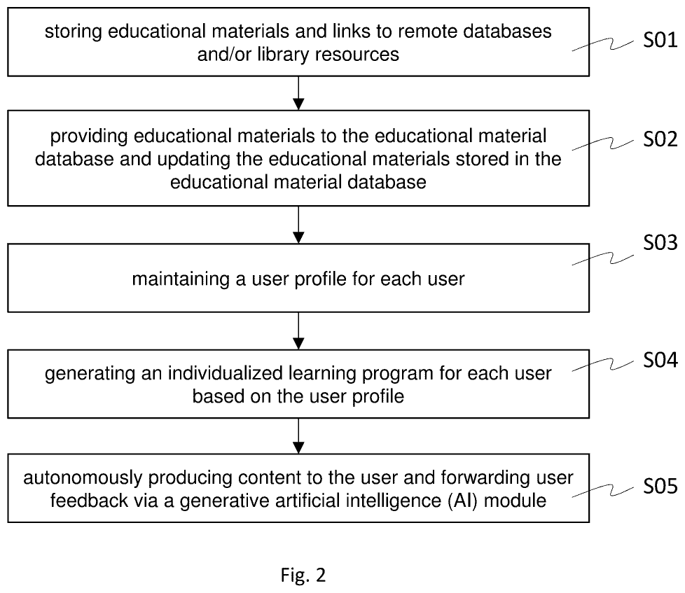

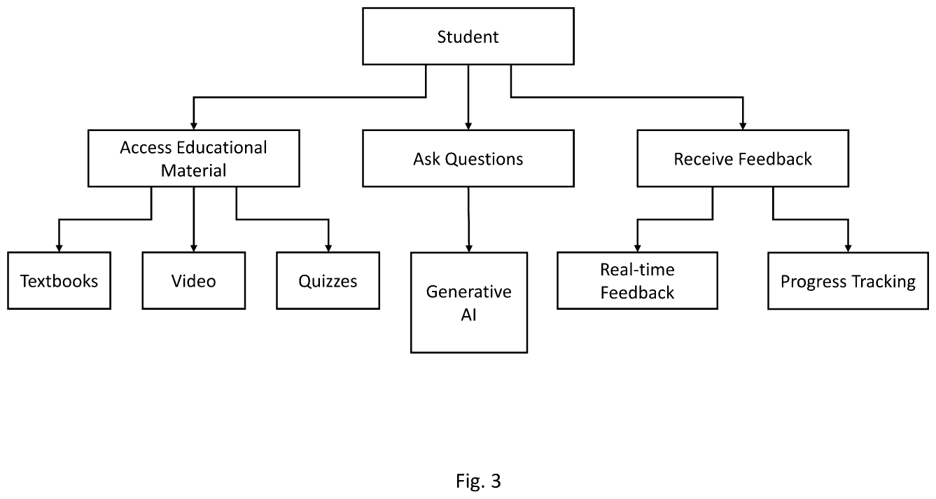

For a better understanding of the present invention, please refer to FIG. 2 which is a flowchart illustrating a method for providing individualized and interactive remote education according to an embodiment of the present invention, along with FIGS. 3˜6 which provide conceptual overviews of the invention from various viewpoints.

The present invention introduces a method for providing individualized and interactive remote learning experiences. The method includes a series of steps aimed at maximizing the effectiveness and adaptability of educational content. The initial step (S01) involves the storage of educational materials along with links to remote databases and library resources in the educational material database 101 which serves as a dynamic repository, creating a robust foundation for a diverse range of learning materials.

Step S02 focuses on not only providing educational materials to the educational material database 101 but also emphasizes the importance of regularly updating the content within. This ensures that users have access to the latest and most relevant information, fostering a dynamic and evolving educational environment. The teacher subsystem 102, connected to the educational material database 101, not only provides educational materials to the educational material database 101 but also updates the content stored within.

User-centricity is a key aspect of the invention, as highlighted by step S03. Each user's learning progress is tracked and managed through the maintenance of individual user profiles by the student subsystem 103 which is directly linked to the educational material database 101. The user profiles become the foundation for the subsequent step (S04) in the system, where the assessment subsystem 104, interconnected with both the teacher subsystem 102 and the student subsystem 103, generates personalized learning programs based on the user profiles. This tailored approach recognizes the unique needs, preferences, and progress of each user, thereby enhancing the overall learning experience.

In step S05, the generative AI module 105, connected to the educational material database 101, the teacher subsystem 102, the student subsystem 103, and the assessment subsystem 104, autonomously produces content for users and facilitates seamless communication by forwarding user feedback to the teacher subsystem 102, the student subsystem 103, and the assessment subsystem 104. The integration of the generative AI module not only enhances the efficiency of content delivery but also allows for a dynamic and responsive interaction, adapting to the evolving needs and preferences of each user.

In essence, the present invention establishes a multifaceted and interconnected framework, encompassing an educational material database 101, the teacher subsystem 102, the student subsystem 103, the assessment subsystem 104, and the generative AI module 105, to provide a cutting-edge system for individualized and interactive remote education. This system is poised to redefine the contemporary learning landscape, offering a holistic and adaptive approach to remote learning methodologies.

FIG. 3 provides a conceptual overview of the invention from the student's perspective. In this illustration, a user or student can access educational materials, such as textbooks, videos, and quizzes, from the educational material database 101. The student is also able to pose questions to the Teacher through the generative AI module 105 and receive real-time feedback, including tracking of learning progress.

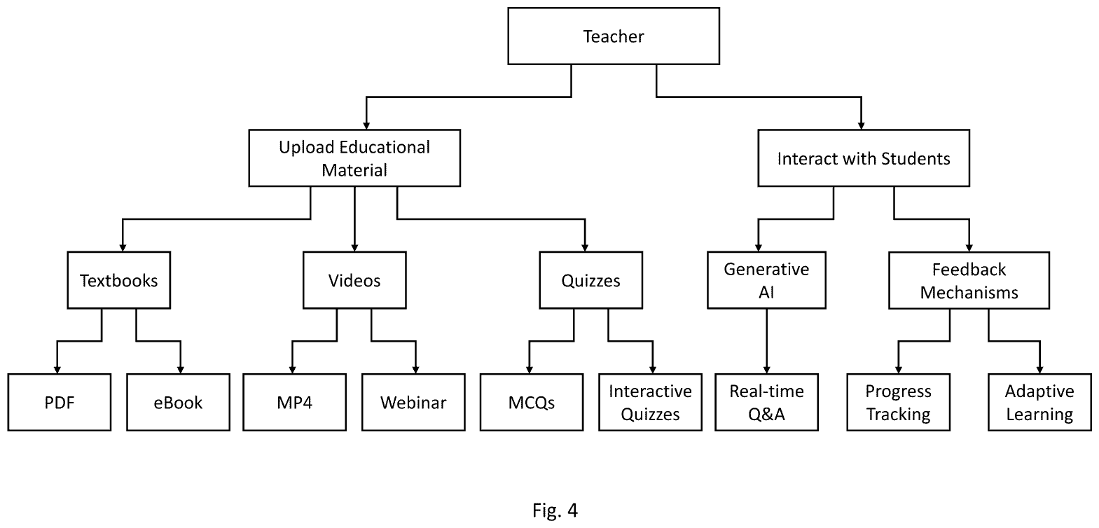

FIG. 4 presents a conceptual overview of the invention from the teacher's perspective. The teacher, through the teacher subsystem 102, has the capability to upload and modify educational materials, such as pdf and/or ebook textbooks, MP4 and/or webinar videos, and Multiple Choice Question (MCQ) and/or interactive quizzes. Additionally, the teacher can engage with students in real-time through the generative AI module 105, conducting Q&A sessions. Feedback mechanisms are available through either the student subsystem 103 or the assessment subsystem 104, enabling progress tracking and adaptive learning.

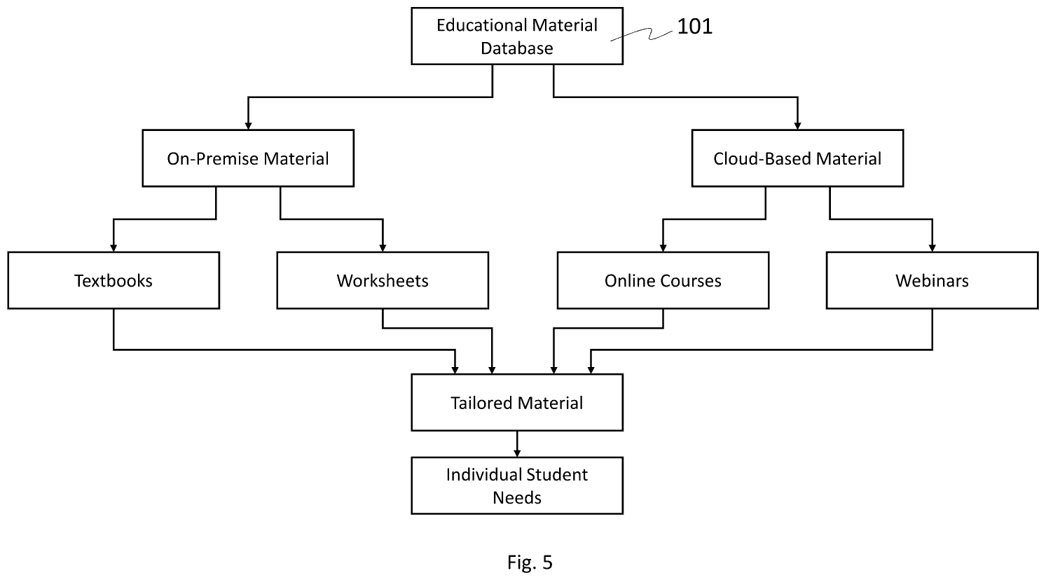

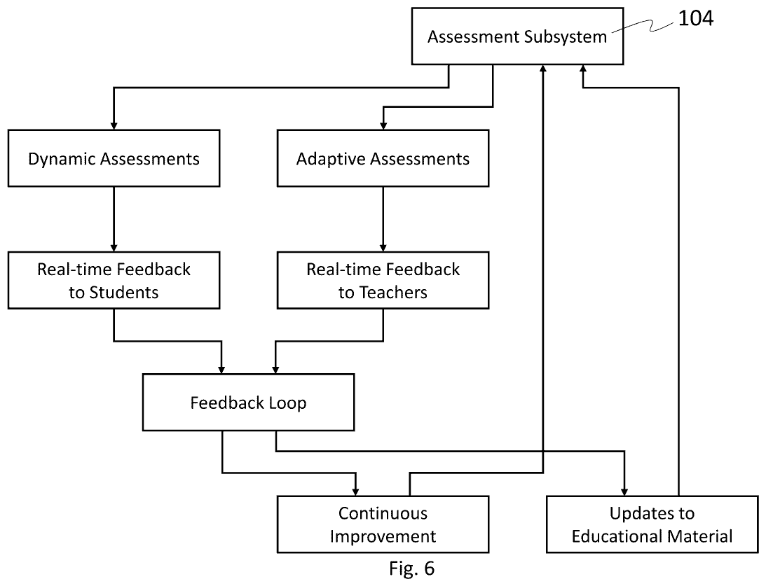

FIG. 5 provides a conceptual overview of the invention from the perspective of the educational material database. The educational material database 101 incorporates a variety of educational materials, including on-premise resources like textbooks and worksheets, as well as cloud-based content such as online courses and webinars. These materials are seamlessly combined to create a customized compilation that caters to the specific needs of each user or student. This tailored approach ensures a comprehensive and adaptive educational experience that can be accessed either locally or through cloud-based platforms.

FIG. 6 offers a conceptual overview of the invention, focusing on the assessment subsystem 104. The assessment subsystem 104 serves a dual purpose by delivering dynamic assessments and real-time feedback to students and adaptive assessments with real-time feedback to teachers. It operates within a continuous improvement framework, incorporating feedback from both students and teachers through a feedback loop. The educational materials within the educational material database 101 are dynamically updated based on the valuable input received from students and teachers, ensuring a responsive and evolving educational experience.

The present invention introduces a comprehensive online education system designed to enhance the learning experience through a diverse range of educational materials. The educational material database, a central component of the system, encompasses more than traditional textbooks, videos, and quizzes. It extends to include interactive simulations and virtual labs, offering students the opportunity to experiment and explore concepts in a virtual environment, particularly in science, engineering, and medicine.

Real-world applications come to life through case studies, fostering critical thinking and problem-solving skills. Discussion forums and online communities provide a collaborative space for students to engage in discussions, share ideas, and ask questions, enhancing the overall learning experience. The system incorporates e-books and articles to supplement textbooks, providing a broader perspective and keeping content up-to-date.

Audio content, such as Podcasts and audio lectures, offers a convenient way for students to consume information on the go. Gamifying the learning process through interactive quizzes and games makes education more engaging and enjoyable. Webinars and guest lectures bring industry experts into the virtual classroom, offering insights beyond the standard curriculum.

Access to peer-reviewed journals deepens students'understanding of specific topics and encourages a research-oriented mindset. Online assessments and self-assessment tools go beyond traditional quizzes, enabling students to track progress and identify areas for improvement. Collaborative documents and cloud-based tools facilitate teamwork on assignments and projects.

The system provides access to online tutors and mentors for personalized guidance, as well as multimedia presentations incorporating infographics, animations, and slideshows to cater to different learning styles. Workbooks and worksheets, whether printable or interactive, serve as valuable resources for practice exercises and concept reinforcement.

For language courses, language learning apps focusing on speaking, listening, reading, and writing skills are integrated. Social media integration encourages collaboration, communication, and resource sharing among students, further enriching the educational experience. In summary, the invention presents a versatile and inclusive online education system that goes beyond traditional boundaries, embracing a wide array of materials and tools to cater to diverse learning needs.

It is to be understood that the specific order or hierarchy of steps in the methods disclosed is an illustration of exemplary processes and may be rearranged based upon design preferences. The accompanying method claims present elements of the various steps in a sample order, and are not meant to be limited to the specific order or hierarchy presented unless specifically recited therein.

Although embodiments have been described herein with respect to particular configurations and sequences of operations, it should be understood that alternative embodiments may add, omit, or change elements, operations and the like. Accordingly, the embodiments disclosed herein are meant to be examples and not limitations.

1. A computer-implemented method for providing individualized and interactive remote education, executed by a processing unit comprising at least one processor and memory storing executable instructions, the method comprising the steps of:
storing, in an educational material database, educational materials and links to remote databases and/or library resources;
providing, by a teacher subsystem connected to the educational material database, educational materials to the educational material database and updating the educational materials stored therein through machine-learning-driven analytics that automatically identify performance gaps across users;
maintaining, by a student subsystem, a user profile for each user comprising real-time engagement metrics and historical learning data automatically updated by the system;
generating, by an assessment subsystem, an individualized learning program for each user based on the user profile, wherein the assessment subsystem employs machine-learning models trained to predict optimal learning sequences; and
autonomously producing, by a generative artificial-intelligence (AI) module, adaptive_content for the user and forwarding user feedback via the generative AI module to update at least one of the teacher subsystem, the student subsystem, and the assessment subsystem in real time to improve subsequent content generation.

2. The method according to claim 1, wherein the user profile comprises academic profile, learning preferences, and historical engagement metrics of the user.

3. The method according to claim 1, wherein the user profile comprises learning styles, preferences, and objectives of the user, and the autonomously produced content is adjusted accordingly by the generative AI module.

4. The method according to claim 1, wherein the user profile comprises a dynamically updated record of a learning progress of the individualized learning program for the user to accomplish, with the learning progress being tracked and accessible.

5. The method according to claim 1, wherein the autonomously produced content is generated by Natural Language Processing (NLP) and Machine Learning (ML) algorithms.

6. The method according to claim 1, wherein the educational materials are dynamically uploaded and modified via machine learning-driven analytics, facilitating real-time engagement and personalized interventions with the user.

7. The method according to claim 1, wherein the generative AI module provides immediate access to a curated and diverse array of educational resources, and delivers AI-driven, real-time feedback based on interactions and performance metrics of the user.

8. The method according to claim 1, wherein the educational material database is deployable in both on-premise and cloud-based environments, offering enhanced content management and distribution flexibility.

9. The method according to claim 1, wherein the educational materials comprise textbooks, videos, and quizzes.

10. The method according to claim 1, wherein difficulty of the individualized learning program is adjusted dynamically based on the user feedback.

11. A computer-implemented system for providing individualized and interactive remote education, comprising:
an educational material database configured to store educational materials and links to remote databases and/or library resources;
a teacher subsystem, operatively connected to the educational material database, configured to provide educational materials to the educational material database and update the educational materials stored therein through machine-learning-driven analytics that automatically identify performance gaps across users;
a student subsystem, operatively connected to the educational material database, configured to maintain a user profile for each user comprising real-time engagement metrics and historical learning data automatically updated by the system;
an assessment subsystem, operatively connected to the teacher subsystem and the student subsystem, configured to generate an individualized learning program for each user based on the user profile, wherein the assessment subsystem employs machine-learning models trained to predict optimal learning sequences and adjust program difficulty dynamically; and
a generative artificial intelligence (AI) module, operatively_connected to the educational material database, the teacher subsystem, the student subsystem, and the assessment subsystem, configured to autonomously produce adaptive content for the user and forward user feedback via the generative AI module to update at least one of the teacher subsystem, the student subsystem, and the assessment subsystem in real time to improve subsequent content generation.

12. The system according to claim 11, wherein the user profile comprises academic profile, learning preferences, and historical engagement metrics of the user.

13. The system according to claim 11, wherein the user profile comprises learning styles, preferences, and objectives of the user, and the autonomously produced content is adjusted accordingly by the generative AI module.

14. The system according to claim 11, wherein the user profile comprises a dynamically updated record of a learning progress of the individualized learning program generated by the assessment subsystem for the user to accomplish, with the learning progress be

[symbol]

15. The system according to claim 11, wherein the autonomously produced content is generated by Natural Language Processing (NLP) and Machine Learning (ML) algorithms.

16. The system according to claim 11, wherein the teacher subsystem is equipped with machine learning-driven analytics that enables the dynamic upload and modification of the educational materials while facilitating real-time engagement and personalized inter

[symbol]

17. The system according to claim 11, wherein the student subsystem provides immediate access to a curated and diverse array of educational resources via the educational material database, and delivers AI-driven, real-time feedback based on interactions and p

[symbol]

18. The system according to claim 11, wherein the educational material database is deployable in both on-premise and cloud-based environments, offering enhanced content management and distribution flexibility.

19. The system according to claim 11, wherein the educational materials comprise textbooks, videos, and quizzes.

20. The system according to claim 11, wherein difficulty of the individualized learning program is adjusted dynamically based on the user feedback.
